(19) United States
(12) Patent Application Publication
(10) Pub. No.: US 2024/0217021 A1
(43) Pub. Date: Jul. 4, 2024

(54) REPAIR WELDING OF SPHEROIDAL GRAPHITE CAST IRON

(71) Applicant: SIEMENS ENERGY GLOBAL GMBH & CO. KG, Munich (DE)

(72) Inventors: Stefan Brussk, Mülheim an der Ruhr (DE); Alexander Luithle, Bochum (DE); Tim Schreiber, Witten (DE)

(21) Appl. No.: 18/602,547

(22) Filed: Mar. 12, 2024

Related U.S. Application Data
(62) Division of application No. 17/050,488, filed on Oct. 26, 2020.

(30) Foreign Application Priority Data
May 23, 2018 (EP) 18173878.2

(51) Int. Cl. B23K 9/173; B23K 9/04; B23K 9/167; B23K 35/30; B23K 35/38; B23K 103/06

(52) U.S. Cl. CPC B23K 9/173; B23K 9/04; B23K 9/167; B23K 35/3066; B23K 35/383; B23K 2103/06

(57) ABSTRACT

A method for weld repairing a surface of a base material, wherein the base material has spheroidal graphite cast iron, wherein firstly a partial surface is configured, in a further step a two-ply buffer layer is used by means of MIG welding with the welding additive NiFe, wherein in a further step a fill layer is applied to the buffer layer, wherein the MIG welding method is used in conjunction with NiFe-2 in accordance with EN ISO 107 as welding additive material.

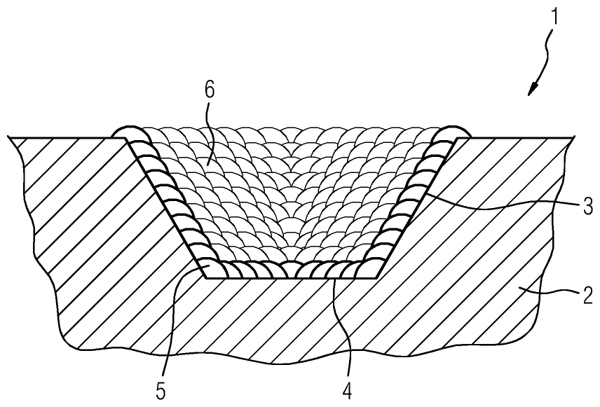

### CROSS REFERENCE TO RELATED APPLICATIONS

This application is a divisional application of U.S. application Ser. No. 17/050,488 which is the US National Stage of International Application No. PCT/EP2019/060585 filed 25 Apr. 2019, and claims the benefit thereof. The International Application claims the benefit of European Application No. EP18173878 filed 23 May 2018. All of the applications are incorporated by reference herein in their entirety.

### FIELD OF INVENTION

The invention relates to a method for producing a surface of a base material, wherein the base material comprises cast iron.

### BACKGROUND OF INVENTION

Cast components produced from spheroidal graphite cast iron are used for example in turbomachines, such as for example in steam turbines. These cast components can be of large volume configuration. During the production of the cast component, casting defects such as for example pores or cavities may arise. A decision must be made here, on a case-by-case basis, as to whether the cast component with the existing defects can be used without further measures. Welding-related machining of such cast components is only partially possible. By way of example, welding with the same type of weld metal would be difficult, since it is necessary to use a high preheating temperature which must lie between 550° C. and 650° C. A further possibility for eliminating the casting defects is to weld using different types of welding additive, for example Ni—Fe electrodes, which does not necessitate any increased preheating temperatures.

However, in both welding operations, the problem is that the mechanical properties obtained by the respective process frequently do not achieve the mechanical properties of the base material.

A decision must therefore be made, on a case-by-case basis, as to whether the cast component needs to be rejected or/and remanufactured.

Damage to cast iron components must be repaired not only during remanufacture but also in service, since manufacture of new components is not possible in short overhaul periods.

### SUMMARY OF INVENTION

It is the object of the invention to specify a method for producing a surface of a base material, having improved quality.

This object is achieved by a method for producing a surface of a base material, wherein the base material comprises cast iron, having the steps of:—localizing a partial surface, producing a first buffer layer on the partial surface, wherein a buffer welding process is used in conjunction with a buffer welding additive, wherein the welding parameters are selected such that the heat input into the base material is low,—producing a fill layer on the buffer layer, wherein the MAG welding process is used, wherein a NiFe welding filler material is used, wherein no preheating is performed.

Advantageous developments are specified in the subclaims.

The invention thus aims to specify a welding method using arc welding processes, which manages without, or with low, preheating temperatures and which achieves properties comparable to the base material.

The welding method involves a two-stage process with a welding filler material which is matched to the welding task and the welding process and which has a considerable influence on the quality of the welding. As a result of targeted selection of the welding process, the welding filler material and the welding parameters, it is possible to prevent both defects in the connection to the base material and defects in the weld metal or the filling.

According to the invention, the connection to the base material is initially created by way of a buffer. In a second step, the filling is subsequently realized.

The welding method/process according to the invention makes it possible to produce manufacturing and repair welds which meet the mechanical properties of the base material. This takes place at low temperatures (free of condensation, about 100° C.) and thus facilitates the welding on finished or virtually finished components, since the warpage is minimized as a result of the low heat input.

An essential advantage is that, during the remanufacturing of cast iron components in which casting defects have been introduced for example during the material-removing machining, can be repaired by the welding according to the invention. Rejection of the cast iron component, together with any associated time-consuming remanufacturing, is therefore not necessary.

For components which are already in use and in which damage in the form of cracks, material abrasion or the like has been detected, for example in the course of an overhaul, the method according to the invention lends itself to reconditioning said components using welding technology. Consequently, a prolongation of the overhaul period is often not required.

In a first advantageous development, the base material comprises spheroidal graphite cast iron.

In a further advantageous development, the WIG welding process is employed as buffer welding process, wherein NiFe welding additive (NiFe-2 type in accordance with EN ISO 1071) is used as welding additive.

As an alternative thereto, the MIG welding process can be employed as buffer welding process, wherein NiFe welding additive of NiFe-1 type in accordance with EN ISO 1071 is used as welding additive.

The MIG process can also be used during the production of the fill layer, wherein a NiFe welding filler material is used, in particular a NiFe welding additive.

In a further advantageous development, a second buffer layer is applied prior to production of the fill layer.

The above-described properties, features and advantages of this invention and the manner in which they are achieved will become more clearly and distinctly comprehensible in connection with the following description of the exemplary embodiments, which are explained in more detail in connection with the drawings.

Exemplary embodiments of the invention are described below with reference to the drawing. This drawing is not intended to definitively represent the exemplary embodiments.

Rather, the drawing is implemented in a schematic and/or slightly distorted form where this is useful for explanation. With regard to additions to the teachings which are directly evident from the drawing, reference is made to the relevant prior art.

### BRIEF DESCRIPTION OF THE DRAWINGS

In the drawing:

The sole FIGURE shows a sectional illustration through a component.

### DETAILED DESCRIPTION OF INVENTION

The figure shows a component 1 which has been produced by a casting process. The base material 2 comprises spheroidal graphite cast iron. The component 1 has a partial surface 3, wherein the partial surface 3 is configured in the form of an indentation 4. In order to connect the weld metal to the base material 2, the WIG welding process, in conjunction with a NiFe welding additive (NiFe-2 type in accordance with EN ISO 1071), is selected and implemented in two layers, wherein the welding parameters are selected such that the heat input into the base material 2 is low.

In a first step, the partial surface 3 is thus localized. In a next step, a first buffer layer 5 is applied on the partial surface 3. With the suitably selected welding parameters, what is achieved is that no cracks occur in the connection and in the heat-affected zone, and the heat-affected zone is of comparatively narrow and uniform configuration. As a result of the welding parameter selection of the second WIG layer, the heat-affected zone relative to the base material 2 is influenced in a thermally targeted manner and thus the mechanical properties are optimized.

As an alternative to the WIG welding process, it is also possible to make use of a MIG welding process whose parameters are likewise modified to such an extent that the heat input into the base material is low. A NiFe welding additive (NiFe-1 type in accordance with EN ISO 1071) is employed as welding additive.

In a further step, if the two-layer buffer is not sufficient to even out the component, a fill layer 6 is applied on the buffer layer 5. This is performed by means of fill welding using the MIG welding process. In this MIG welding process, a NiFe welding filler material is likewise employed, which is identical to the welding filler material used during the WIG welding operation for connection to the first layer.

The production of the surface takes place in such a way that no preheating is performed, or is carried out at temperatures of less than 100° C.

Argon is used during the production of the buffer layer, wherein a mixture of argon and CO₂ is used during the production of the fill layer.

The MIG welding process can be employed as buffer welding process, wherein a welding additive is used which comprises substantially 65% by weight of Ni and substantially 30% by weight of Fe.

During the production of the fill layer, a welding additive is used which comprises substantially 55% by weight of Ni and substantially 30% by weight of Fe.

The WIG welding process can also be used as buffer welding process, wherein both during the buffer welding process and during the MAG welding process a welding additive is used which comprises substantially 55% by weight of Ni and substantially 30% by weight of Fe.

Although the invention has been described and illustrated in greater detail by the preferred exemplary embodiment, the invention is not limited by the disclosed examples and other variations can be derived therefrom by a person skilled in the art without departing from the scope of protection of the invention.

1. A method for weld repairing a surface of a base material, wherein the base material comprises cast iron, the method comprising:
configuring a partial surface only on the surface of the base material, producing a buffer layer on the partial surface, wherein a buffer welding process is used in conjunction with a buffer welding material, the buffer layer is applied prior to a fill layer and the buffer layer is applied on the partial surface preventing contact between the fill layer and the base material,
wherein welding parameters of the buffer welding process are selected such that a heat input into the base material is low and the base material does not crack in a heat effected zone, producing the fill layer on the buffer layer with a fill welding process,
wherein no preheating is performed,
wherein a MIG welding process is employed during the buffer welding process, and the buffer welding material used during the buffer welding process comprises at least 55% by weight of Ni and substantially 30% by weight of Fe,
wherein, during the fill welding process a fill welding material is used which comprises substantially 55% by weight of Ni and substantially 30% by weight of Fe.

2. The method as claimed in claim 1, wherein argon is used during the production of the buffer layer; wherein a mixture of argon and CO₂ is used during the production of the fill layer.

3. The method as claimed in claim 1, wherein a WIG welding process is used during the buffer welding process and a MAG welding process is used during the fill welding process, wherein the buffer welding material and the fill welding material both comprise substantially 55% by weight of Ni and substantially 30% by weight of Fe.

4. The method as claimed in claim 1, wherein the base material comprises spheroidal graphite cast iron.

5. The method as claimed in claim 1, wherein the partial surface is configured to form an indentation.

6. The method as claimed in claim 1, wherein a WIG welding process is employed as the buffer welding process.

7. The method as claimed in claim 1, wherein the buffer welding material is used as the fill welding material.

8. The method as claimed in claim 1, wherein the MIG welding process is employed as the fill welding process.

9. The method as claimed in claim 8, wherein the buffer welding material is used as the fill welding material.

10. The method as claimed in claim 1, wherein the buffer layer further comprises a first buffer layer and a second buffer layer, both of which are applied prior to production of the fill layer.

11. The method as claimed in claim 1, wherein production of the buffer welding process takes place at temperatures below 100° C.

12. A repair of a component for a turbomachine, produced by a method as claimed in claim 1.

13. The method as claimed in claim 1, wherein the buffer welding material or the fill welding material comprises a NiFe-2 type in accordance with EN ISO 1071.

14. The method as claimed in claim 7, wherein the buffer welding material comprises NiFe-2 type in accordance with EN ISO 1071.

15. The method as claimed in claim 1, wherein the buffer welding material comprises NiFe-1 type in accordance with EN ISO 1071.
